(19) United States
(12) Patent Application Publication
(10) Pub. No.: US 2026/0269669 A1
(43) Pub. Date: Sep. 10, 2026

(54) ROTATING ELECTRIC MACHINE

(71) Applicant: HONDA MOTOR CO., LTD., Tokyo (JP)

(72) Inventor: Tatsunoshin Ishikawa, Wako-shi (JP)

(21) Appl. No.: 19/553,838

(22) Filed: Mar. 2, 2026

(30) Foreign Application Priority Data
Mar. 5, 2025 (JP) 2025-034205

(51) Int. Cl. H02K 1/2792

(52) U.S. Cl. CPC H02K 1/2792

(57) ABSTRACT

A rotating electric machine includes a rotor and a stator, wherein the rotor includes a plurality of magnets arranged in a Halbach array along a circumferential direction of the rotor, and a magnet retaining member retaining the plurality of magnets, the magnet retaining member includes a base portion including a magnet retaining surface along the circumferential direction of the rotor, a plurality of rod portions protruding from the base portion along a radial direction of the rotor, and a flange portion protruding from a protruding end of each of the rod portions along the circumferential direction of the rotor, the magnets are each sandwiched and retained between the base portion and the flange portion, magnetization directions of two magnets adjacent to each other with one of the rod portions interposed between the two magnets are both along the radial direction or the circumferential direction of the rotor.

### CROSS-REFERENCE TO RELATED APPLICATIONS

This application is based upon and claims the benefit of priority from Japanese Patent Application No. 2025-034205 filed on Mar. 5, 2025, the contents of which are incorporated herein by reference.

### BACKGROUND OF THE INVENTION

### FIELD OF THE INVENTION

The present disclosure relates to a rotating electric machine.

### DESCRIPTION OF THE RELATED ART

JP 2013-135506 A discloses an inner rotor type motor. A rotating part (rotor) of the motor includes a rotor core, a plurality of magnets arranged in a circumferential direction, and a plurality of magnet holders that hold the magnets.

### SUMMARY OF THE INVENTION

There is a demand for a more satisfactory rotating electric machine.

An object of the present disclosure is to meet the aforementioned need.

An aspect of the present disclosure is characterized by a rotating electric machine including a rotor and a stator, wherein the rotor includes a plurality of magnets arranged in a Halbach array along a circumferential direction of the rotor, and a magnet retaining member configured to retain the plurality of magnets, the magnet retaining member includes a base portion including a magnet retaining surface along the circumferential direction of the rotor, a plurality of rod portions protruding from the base portion along a radial direction of the rotor, and a flange portion protruding from a protruding end of each of the rod portions along the circumferential direction of the rotor, the magnets are each sandwiched and retained between the base portion and the flange portion, and magnetization directions of two of the magnets adjacent to each other with one of the rod portions interposed between the two magnets are both along the radial direction of the rotor or both along the circumferential direction of the rotor.

According to the present disclosure, a more satisfactory rotating electric machine can be obtained.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic vertical cross-sectional view of a rotating electric machine;

FIG. 2 is a partially enlarged view of a cross section taken along line II-II of FIG. 1;

FIG. 3 is a partially enlarged view of a rotating electric machine according to a first embodiment;

FIG. 4 is a partially enlarged view of a rotating electric machine according to a second embodiment;

FIG. 5 is a partially enlarged view of a rotating electric machine according to a first modification;

FIG. 6 is a partially enlarged view of a rotating electric machine according to a second modification;

FIG. 7 is a partially enlarged view of a rotating electric machine according to a third modification;

FIG. 8 is a partially enlarged view of a rotating electric machine according to a fourth modification;

FIG. 9 is a schematic view of a magnet retaining member according to a fifth modification; and

FIG. 10 is a cross-sectional view taken along line X-X of FIG. 9.

### DETAILED DESCRIPTION OF THE INVENTION

A rotor of a rotating electric machine includes a plurality of magnets. The plurality of magnets are arranged along a circumferential direction of the rotor and retained by a retaining member such as a core. For example, the plurality of magnets are fixed to the retaining member by an adhesive. Alternatively, the plurality of magnets are pressed in the radial direction by the reinforcing ring and fixed to the retaining member.

A first rotating electric machine in which the magnets are fixed to the retaining member by means of an adhesive is excellent in terms of high torque. However, the fixing strength of the fixing by means of an adhesive is inferior to that of the mechanical fixing. Therefore, the first rotating electric machine has a concern that the strength of the rotor is insufficient. The magnets are preferably fixed to the retaining member by a fixing means other than an adhesive.

A second rotating electric machine in which the magnets are pressed in the radial direction by a reinforcing ring and fixed to the retaining member has strength. However, in the case that the reinforcing ring is interposed between the circumferential surface of the rotor and the circumferential surface of the stator, the separation distance between the rotor and the stator increases. Therefore, there is a concern that the torque of the second rotating electric machine decreases. The same concern as that of the reinforcing ring is also present in a rotating electric machine such as an IPM (interior permanent magnet) motor.

A rotating electric machine having a plurality of magnets arranged in a Halbach array is excellent in terms of high torque. The present disclosure described below enables a rotating electric machine having a plurality of magnets arranged in a Halbach array to suppress a decrease in torque while ensuring the strength of a rotor.

### 1 Rotating Electric Machine

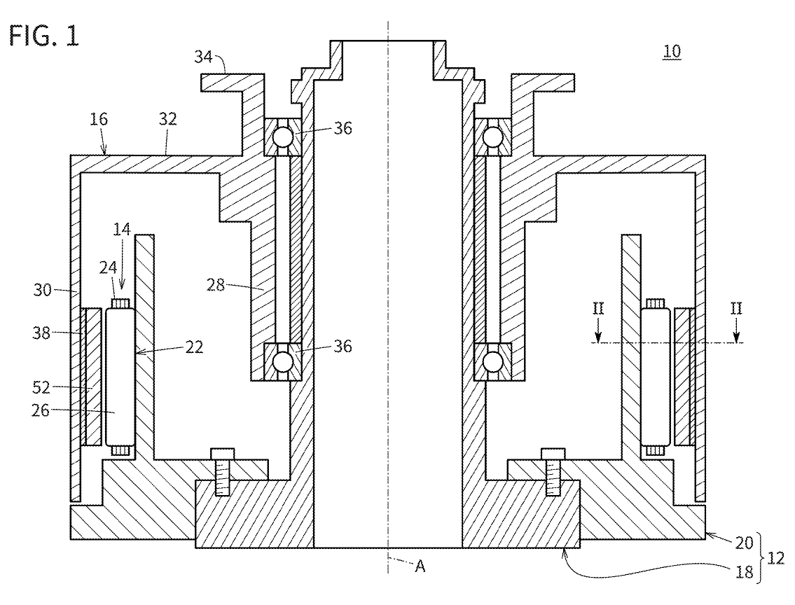

FIG. 1 is a schematic vertical cross-sectional view of a rotating electric machine 10. The rotating electric machine 10 described below may be either an electric motor or an electrical power generator. The rotating electric machine 10 shown in FIG. 1 is an outer rotor type, but the rotating electric machine 10 may be an inner rotor type. In the following description, a "radial direction" means a radial direction of a circle centered on an axis A of the rotating electric machine 10. Further, a "circumferential direction" means the circumferential direction of the circle centered on the axis A of the rotating electric machine 10. In a plan view, a clockwise direction around the axis of the rotating electric machine 10 is referred to as a C1 direction, and a counterclockwise direction is referred to as a C2 direction.

The rotating electric machine 10 includes a housing member 12, a stator 14, and a rotor 16. Each of the rotating electric machine 10, the housing member 12, the stator 14, and the rotor 16 has the same axis. Hereinafter, each axis is referred to as the "axis A".

The housing member 12 includes an inner housing 18 and a stator housing 20. The inner housing 18 and the stator housing 20 are connected to each other at one end of the rotating electric machine 10. The inner housing 18 has a substantially cylindrical part centered on the axis A. The inner circumferential surface of the inner housing 18 defines the inner circumferential surface of the rotating electric machine 10. That is, a hollow space penetrating along the axial direction is formed at the center of the rotating electric machine 10. An inner cylinder portion 28 of the rotor 16 is attached to the outer periphery of the inner housing 18 via two bearings 36. The stator housing 20 has a substantially cylindrical part centered on the axis A. The stator housing 20 is disposed radially outward of the inner housing 18. The stator 14 is attached to the outer periphery of the stator housing 20.

The stator 14 includes a stator core 22 and electromagnetic coils 24 of respective phases. The stator core 22 has a substantially cylindrical shape centered on the axis A. The stator core 22 includes a plurality of teeth 26 that protrude radially outward. The coils 24 are disposed between the two adjacent teeth 26. The inner periphery of the stator core 22 is attached to the stator housing 20. The stator 14 is retained by the stator housing 20.

The rotor 16 includes the inner cylinder portion 28, an outer cylinder portion 30, a connecting portion 32, and an external retaining portion 34. The inner cylinder portion 28, the outer cylinder portion 30, the connecting portion 32, and the external retaining portion 34 serve as a rotor shaft. Each of the inner cylinder portion 28 and the outer cylinder portion 30 has a substantially cylindrical shape centered on the axis A. The inner cylinder portion 28 is disposed radially inward of the outer cylinder portion 30. The outer cylinder portion 30 is disposed radially outward of the inner cylinder portion 28. The connecting portion 32 connects the inner cylinder portion 28 and the outer cylinder portion 30. The external retaining portion 34 protrudes upward from the connecting portion 32. In the case that the rotating electric machine 10 is an electric motor, for example, wheels, a propeller, and the like are connected to the external retaining portion 34. When the rotating electric machine 10 is an electrical power generator, an internal combustion engine or the like is coupled to the external retaining portion 34, for example. The inner housing 18 is attached to the inner periphery of the inner cylinder portion 28 via the two bearings 36 arranged in the vertical direction. The inner cylinder portion 28 is retained by the inner housing 18 via the two bearings 36.

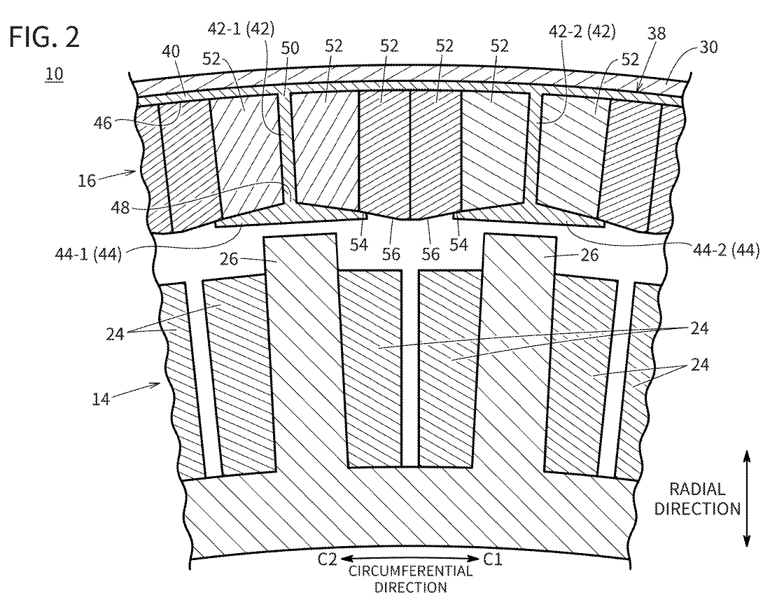

FIG. 2 is a partially enlarged view of a cross section taken along line II-II of FIG. 1. A magnet retaining member 38 is attached to the inner periphery of the outer cylinder portion 30. The magnet retaining member 38 serves as a rotor core (yoke). The magnet retaining member 38 retains a plurality of magnets 52. The magnet retaining member 38 includes a base portion 40, a plurality of rod portions 42, and a plurality of flange portions 44. The base portion 40, the plurality of rod portions 42, and the plurality of flange portions 44 are integrally formed as the same member. For example, the magnet retaining member 38 is formed by stacking plate members taken out from a material by punching, wire cutting, or the like.

The base portion 40 has a magnet retaining surface 46 along the circumferential direction of the rotor 16 on the inner circumferential side. The rod portions 42 protrude from the base portion 40 along the radial direction of the rotor 16. The rod portions 42 protrude from the base portion 40 toward the stator 14. Here, the rod portions 42 protrude radially inward. The plurality of rod portions 42 are arranged at equal intervals along the circumferential direction so as to surround the outer circumference of the stator 14. Each of the flange portions 44 protrudes from a protruding end 48 of each of the rod portions 42 along the circumferential direction of the rotor 16. In other words, each of the flange portions 44 protrudes from the protruding end 48 of each of the rod portions 42 in both the C1 direction and the C2 direction in a plan view. Each of the flange portions 44 has a substantially T-shape in a plan view. The plurality of flange portions 44 are arranged at equal intervals along the circumferential direction. Two of the adjacent flange portions 44 are spaced apart from each other.

The rotor 16 has the plurality of magnets 52 arranged along the circumferential direction. The plurality of magnets 52 are arranged so as to surround the outer periphery of the stator 14 together with the plurality of rod portions 42. Here, the plurality of magnets 52 are located radially inward of the base portion 40 and radially outward of the flange portions 44. The plurality of magnets 52 include magnets 52 in abutment with the rod portions 42 and magnets 52 not in abutment with the rod portions 42.

Between a first rod portion 42-1 and a second rod portion 42-2 adjacent to each other, a plurality of the magnets 52, here, four of the magnets 52 are positioned. One of the four magnets 52 is in abutment with the first rod portion 42-1. One of the four magnets 52 is in abutment with the second rod portion 42-2. Two of the four magnets 52 are not in abutment with either the first rod portion 42-1 or the second rod portion 42-2. Each of the four magnets 52 is in contact with the magnet retaining surface 46 of the base portion 40. Each of the two magnets 52 closer to the first rod portion 42-1 among the four magnets 52 is sandwiched and retained between the base portion 40 and a first flange portion 44-1 formed on the first rod portion 42-1. Each of the two magnets 52 closer to the second rod portion 42-2 among the four magnets 52 is sandwiched and retained between the base portion 40 and a second flange portion 44-2 formed on the second rod portion 42-2. With the above structure, the radial movement of all the magnets 52 is restricted by the base portion 40 and the flange portions 44. Further, the circumferential movement of all the magnets 52 is directly or indirectly restricted by the rod portions 42. In this way, all the magnets 52 are retained by the magnet retaining member 38.

The two magnets 52 that are not in abutment with either the first rod portion 42-1 or the second rod portion 42-2 include contact portions 54 and protruding portions 56 that are located radially inward. Each of the contact portions 54 is in contact with the flange portion 44. In contrast, each of the protruding portions 56 is not contact with the flange portion 44. The protruding portions 56 are located between the two flange portions 44 within a range in which the protruding portions 56 do not protrude radially inward compared with the two flange portions 44. A part of a radially inner surface of the protruding portion 56 and a radially inner surface of the flange portion 44 are arranged on substantially the same circle centered on the axis A. According to this structure, the volume of the magnets 52 is increased, and thus the torque of the rotating electric machine 10 can be increased.

The plurality of magnets 52 are arranged in the Halbach array along the circumferential direction. Hereinafter, two embodiments (a first embodiment and a second embodiment) in which the positions of the rod portions 42 with respect to the plurality of magnets 52 arranged in the Halbach array are different from each other, and a plurality of modifications related to each embodiment will be described.

### 2 First Embodiment

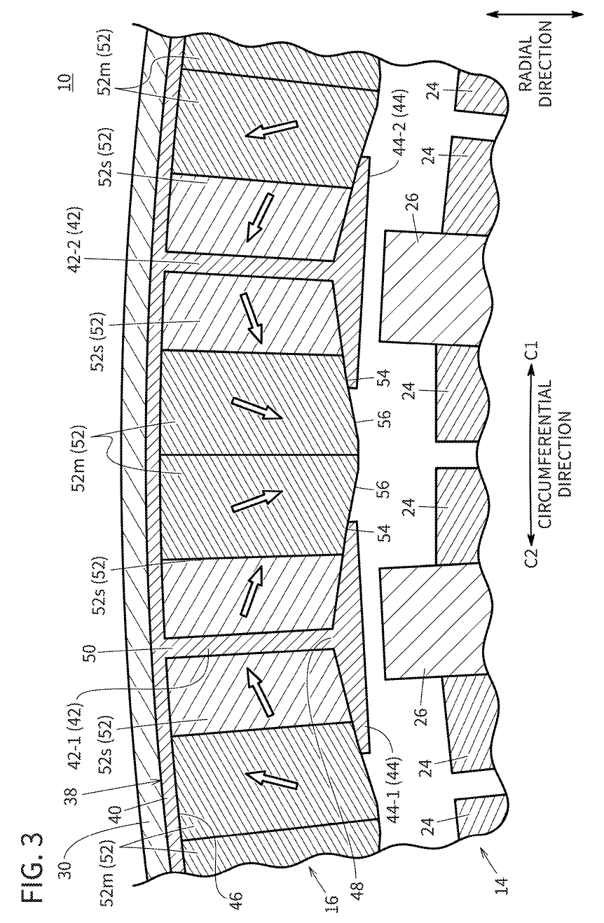

FIG. 3 is a partially enlarged view of the rotating electric machine 10 according to the first embodiment. In FIG. 3, white arrows indicate the magnetization directions of the magnets 52. In the present specification, the magnet 52 whose magnetization direction is along the radial direction of the rotor 16 is referred to as a main magnet 52m. More particularly, the magnet 52 whose magnetization direction is deviated from the radial direction of the rotor 16 by less than 45 degrees is referred to as the main magnet 52m. The magnet 52 whose magnetization direction is along the circumferential direction of the rotor 16 is referred to as a subsidiary magnet 52s. More particularly, the magnet 52 whose magnetization direction is deviated from the tangential direction of the rotor 16 by less than 45 degrees is referred to as the subsidiary magnet 52s. The circumferential length of the main magnet 52m is longer than the circumferential length of the subsidiary magnet 52s. The plurality of magnets 52 attached to the rotor 16 are either the main magnets 52m or the subsidiary magnets 52s.

In the first embodiment, the magnetization directions of the two magnets 52 adjacent to each other with the rod portion 42 interposed therebetween are both along the circumferential direction of the rotor 16. That is, each of the two magnets 52 adjacent to each other with the rod portion 42 interposed therebetween is the subsidiary magnet 52s. The magnetization direction of the two subsidiary magnets 52s adjacent to the first rod portion 42-1 is substantially the C1 direction. The magnetization direction of the two subsidiary magnets 52s adjacent to the second rod portion 42-2 is substantially the C2 direction.

In the first embodiment, two magnets 52 having substantially the same magnetization direction are grouped as one set, and the magnets 52 of each set are arranged in the Halbach array along the circumferential direction. One set of the subsidiary magnets 52s whose magnetization directions are substantially in the C1 direction is in abutment with one set of the main magnets 52m whose magnetization directions face substantially radially inward. Further, one set of the main magnets 52m whose magnetization directions face substantially radially inward is in abutment with one set of the subsidiary magnets 52s whose magnetization directions are substantially in the C2 direction. Further, one set of the subsidiary magnets 52s whose magnetization directions are substantially in the C2 direction is contiguous with one set of the main magnets 52m whose magnetization directions face substantially radially outward. Further, one set of the main magnets 52m whose magnetization directions face substantially radially outward is in abutment with one set of the subsidiary magnets 52s whose magnetization directions are substantially in the C1 direction.

In a set of the subsidiary magnets 52s whose magnetization directions are substantially in the C1 direction, the first rod portion 42-1 is disposed between one of the subsidiary magnets 52s and the other of the subsidiary magnets 52s. Similarly, in a set of the subsidiary magnets 52s whose magnetization directions are substantially in the C2 direction, the second rod portion 42-2 is disposed between one of the subsidiary magnets 52s and the other of the subsidiary magnets 52s. All the subsidiary magnets 52s of the plurality of magnets 52 are in abutment with the rod portions 42 (the first rod portions 42-1 or the second rod portions 42-2).

The performance of the rotating electric machine 10 varies depending on the combination of the magnetization directions of the magnets 52 in abutment with the rod portions 42 and the material of the rod portions 42 and the flange portions 44. In the case that the two magnets 52 in abutment with the rod portions 42 are the subsidiary magnets 52s, the rod portions 42 and the flange portions 44 are preferably formed of non-magnetic bodies. For example, the rod portions 42 are formed of stainless steel having no magnetism.

In the case that the subsidiary magnets 52s are in abutment with the rod portions 42 and the flange portions 44 are formed of a magnetic material, a short-circuit of circumferential magnetic flux occurs, which leads to a reduction in torque of the rotating electric machine 10. Therefore, in the case that the subsidiary magnets 52s are in abutment with the rod portions 42, the flange portions 44 are formed of a non-magnetic material, and thus it is possible to suppress a reduction in torque. In the case that the rod portions 42 and the flange portions 44 are made of a non-magnetic body, the magnetization direction in which the torque reduction can be suppressed more than when the rod portions 42 and the flange portions 44 are made of a magnetic body, may be defined as being “along the circumferential direction".

According to the results of the experiments conducted by the present inventors and others, the torque of the rotating electric machine 10 including the rod portions 42 formed of a non-magnetic body was higher than the torque of the rotating electric machine 10 including the rod portions 42 formed of a magnetic body. The rod portion 42, however, may be formed of a magnetic body although the torque is reduced.

In the Halbach array, the magnets 52 having different magnetization directions are alternately arranged. In the first embodiment, the set of subsidiary magnets 52s and a set of main magnets 52m are alternately arranged. In the case that the main magnet 52m is positioned in the magnetization direction of the subsidiary magnet 52s, a moment caused by the magnetization directions of the two magnets 52 acts on the abutting portion between the subsidiary magnet 52s and the main magnet 52m. Therefore, in the case that the magnets 52 located on both sides of the rod portion 42 are the subsidiary magnet 52s and the main magnet 52m, a rotational force due to the magnetization direction of the magnets 52 is generated in the rod portion 42. In order to resist the rotational force, it is necessary to increase the rigidity of the rod portion 42.

In contrast, in the first embodiment, since the two magnets 52 in abutment with the rod portion 42 have the same magnetization direction, no rotational force due to the magnetization direction of the magnets 52 is generated in the rod portion 42. Therefore, according to the first embodiment, the rod portion 42 does not need to have high rigidity as compared with a case that the two magnets 52 in abutment with the rod portion 42 have different magnetization directions. As a result, the weight of the magnet retaining member 38 can be reduced.

According to the first embodiment, since all the magnets 52 are sandwiched and retained between the base portion 40 and the flange portions 44, the strength of the rotor 16 can be ensured as compared with the case where the magnets 52 are fixed by an adhesive.

In the first embodiment, a part of the main magnet 52m (the protruding portion 56) is located between the two flange portions 44. Therefore, according to the first embodiment, the separation distance between the magnets 52 and the stator 14 can be reduced as compared with a rotating electric machine including a reinforcing ring and a rotating electric machine such as an IPM motor. According to the first embodiment, it is possible to suppress a reduction in torque as compared with a rotating electric machine including a reinforcing ring and a rotating electric machine such as an IPM motor.

According to the first embodiment, it is possible to suppress an increase in a demagnetizing factor as compared with a rotating electric machine in which magnets are fixed with an adhesive.

### 3 Second Embodiment

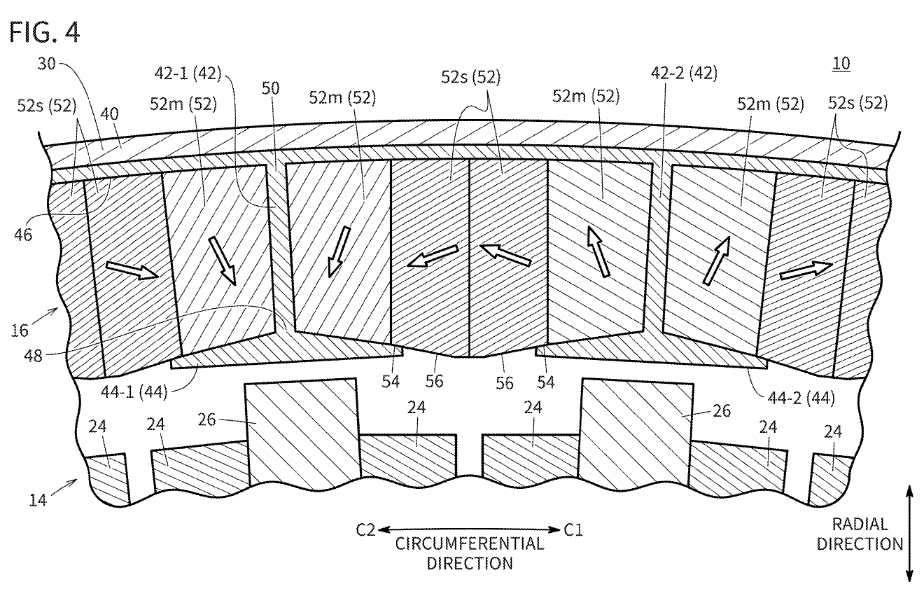

FIG. 4 is a partially enlarged view of the rotating electric machine 10 according to the second embodiment. In the description of the second embodiment, the description of the contents common to the first embodiment will be omitted. In FIG. 4, white arrows indicate the magnetization directions of the magnets 52. In the second embodiment, the magnetization directions of the two magnets 52 adjacent to each other with the rod portion 42 interposed therebetween are both along the radial direction of the rotor 16. That is, each of the two magnets 52 adjacent to each other with the rod portion 42 interposed therebetween is the main magnet 52m. The magnetization direction of the two main magnets 52m in abutment with the first rod portion 42-1 faces substantially radially inward. The magnetization direction of the two main magnets 52m in abutment with the second rod portion 42-2 faces substantially radially outward.

In the same manner as the first embodiment, according to the second embodiment, two magnets 52 having substantially the same magnetization direction are grouped as one set, and the magnets 52 of each set are arranged in the Halbach array along the circumferential direction. The order of arrangement of the main magnets 52m in the second embodiment is the same as the order in the first embodiment.

In a set of the main magnets 52m whose magnetization directions face substantially radially inward, the first rod portion 42-1 is disposed between one of the main magnets 52m and the other of the main magnets 52m. Similarly, in a set of the main magnets 52m whose magnetization directions face substantially radially outward, the second rod portion 42-2 is disposed between one of the main magnets 52m and the other of the main magnets 52m. All the main magnets 52m of the plurality of magnets 52 are in abutment with the rod portions 42 (the first rod portions 42-1 or the second rod portions 42-2).

In the case that the two magnets 52 in abutment with the rod portions 42 are the main magnets 52m, the rod portions 42 and the flange portions 44 are preferably formed of a magnetic body. For example, each of the rod portions 42 is formed of a steel or electromagnetic steel plate having magnetism.

According to the results of the experiments conducted by the present inventors and others, the torque of the rotating electric machine 10 including the rod portions 42 formed of a magnetic body was higher than the torque of the rotating electric machine 10 including the rod portions 42 formed of a non-magnetic body. However, the rod portion 42 may be formed of a non-magnetic body, although the torque is reduced.

In the case that the main magnets 52m are in abutment with the rod portions 42 and the flange portions 44 are formed of a magnetic material, the magnetic flux in the radial direction concentrates on the rod portions 42 and the flange portions 44, compared with the case that the flange portions 44 are formed of a non-magnetic material. Therefore, in the case that the main magnets 52m are in abutment with the rod portions 42, the flange portions 44 are formed of a magnetic material, and thus it is possible to suppress a reduction in torque. In the case that the rod portions 42 and the flange portions 44 are made of a magnetic body, the magnetization direction in which the torque reduction can be suppressed more than when the rod portions 42 and the flange portions 44 are made of a non-magnetic body, may be defined as being "along the radial direction".

In the second embodiment, since the two magnets 52 in abutment with the rod portion 42 have the same magnetization direction, in the same manner as the first embodiment, no rotational force due to the magnetization direction of the magnets 52 is generated in the rod portion 42. Therefore, according to the second embodiment, the rod portion 42 does not need to have high rigidity as compared with a case that the two magnets 52 in abutment with the rod portion 42 have different magnetization directions. As a result, the weight of the magnet retaining member 38 can be reduced.

According to the second embodiment, since all the magnets 52 are sandwiched and retained between the base portion 40 and the flange portions 44, the strength of the rotor 16 can be ensured as compared with the case where the magnets 52 are fixed by an adhesive.

In the second embodiment, a part of the main magnet 52m (a part of the protruding portion 56) is located between the two flange portions 44. Therefore, according to the second embodiment, the separation distance between the magnets 52 and the stator 14 can be reduced as compared with a rotating electric machine including a reinforcing ring and a rotating electric machine such as an IPM motor. According to the second embodiment, it is possible to suppress a reduction in torque as compared with a rotating electric machine including a reinforcing ring and a rotating electric machine such as an IPM motor.

### 4 First Modification

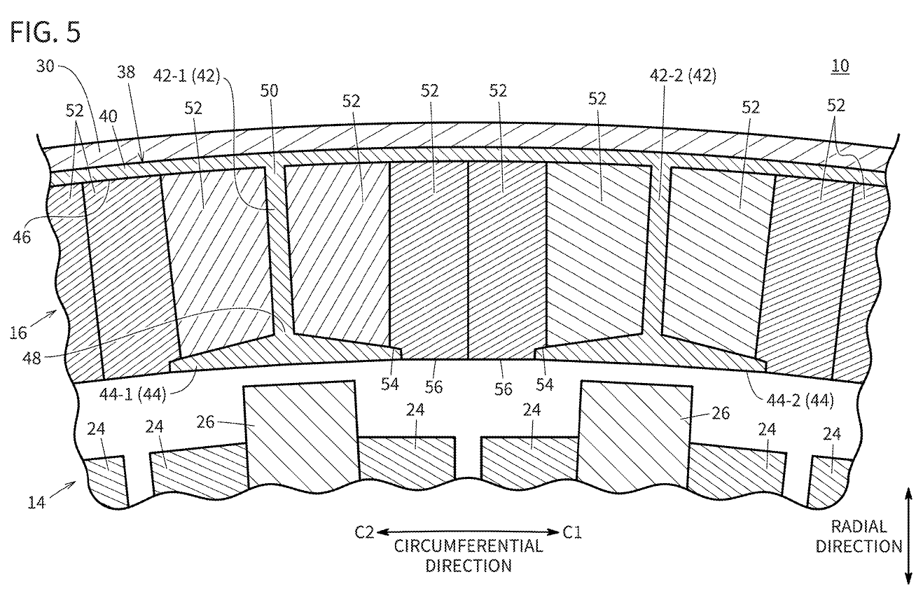

FIG. 5 is a partially enlarged view of a rotating electric machine 10 according to a first modification. The protruding portions 56 of the magnets 52 may have shapes that fill the space between the first flange portion 44-1 and the second flange portion 44-2. For example, the protruding portions 56 may have convex shapes. A radially inner surface of the protruding portion 56 and a radially inner surface of the flange portion 44 are arranged on substantially the same circle centered on the axis A. That is, the distance from the axis A to the radially inner surface of the protruding portion 56 is substantially the same as the distance from the axis A to the radially inner surface of the flange portion 44.

According to the first modification, the volume of the magnets 52 is increased, and thus the torque of the rotating electric machine 10 can be increased.

### 5 Second Modification

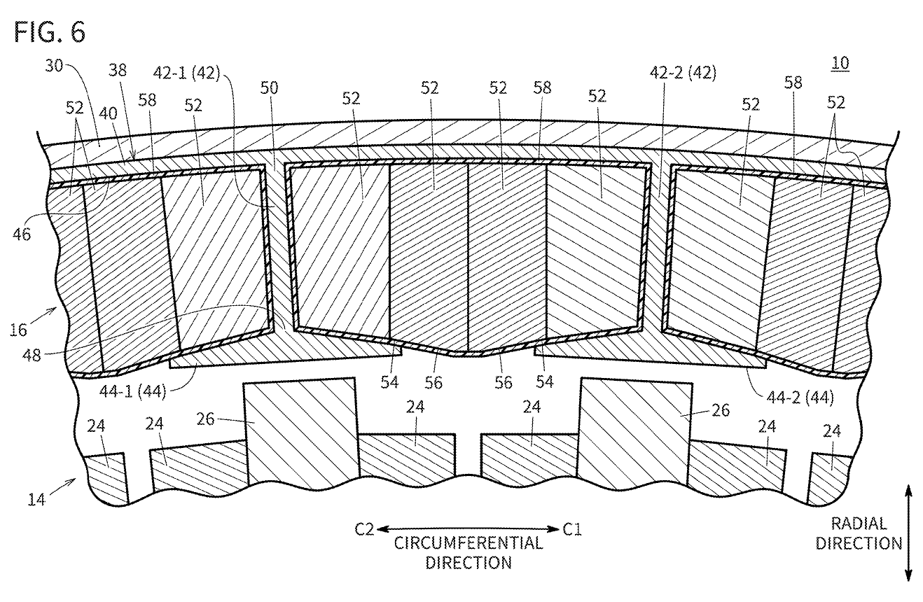

FIG. 6 is a partially enlarged view of a rotating electric machine 10 according to a second modification. A gap may be interposed between the magnets 52 and the magnet retaining member 38. When a gap is present between the magnets 52 and the magnet retaining member 38, there is a concern that the four magnets 52 may move slightly. In order to suppress the movement of the magnets 52, a gap between each of the magnets 52 and the magnet retaining member 38 may be filled with a resin 58. For example, an adhesive (resin 58) may fill the gap in advance by applying to the magnets 52, a large amount of the adhesive (resin 58) for positioning them. Alternatively, the resin 58 may be filled in the gap by vacuum drawing of the resin 58 in a state where the magnet retaining member 38 retains the plurality of magnets 52.

According to the second modification, since the movement of the magnets 52 is suppressed, it is possible to suppress the stress generated in the rod portions 42 due to the movement of the magnets 52.

### 6 Third Modification

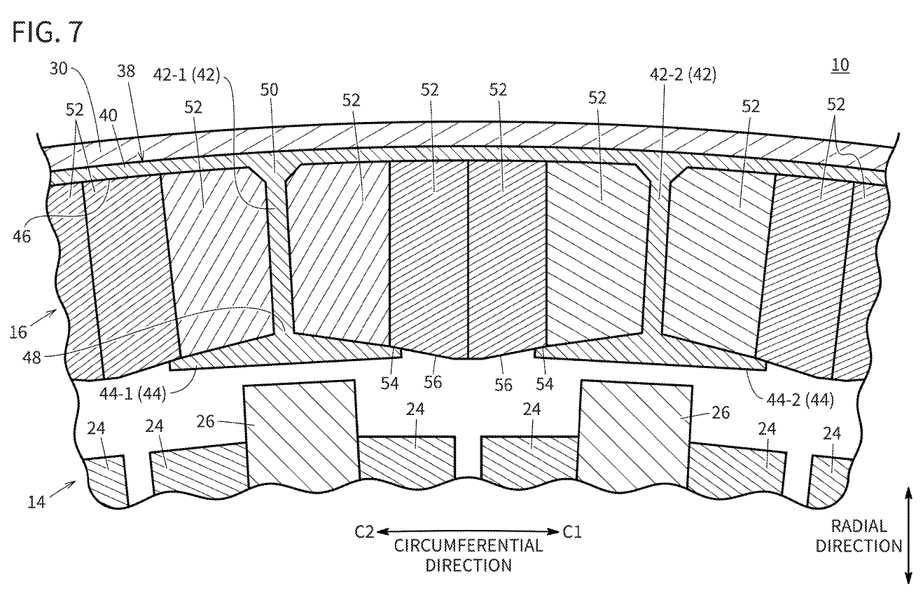

FIG. 7 is a partially enlarged view of a rotating electric machine 10 according to a third modification. A base end portion 50 of each of the rod portions 42 is located at a connection portion between the base portion 40 and the rod portion 42 in the magnet retaining member 38. The magnetic flux passing through the periphery of the base end portion 50 is relatively small. That is, the portion of the magnet 52 located around the base end portion 50 does not contribute to the operation of the rotating electric machine 10. Therefore, as in the third modification, the rod portion 42 (the base end portion 50) may have a shape in which the width thereof increases toward the base portion 40.

According to the third modification, the base end portion 50 is thick, and thus the strength of the rod portion 42 can be increased.

### 7 Fourth Modification

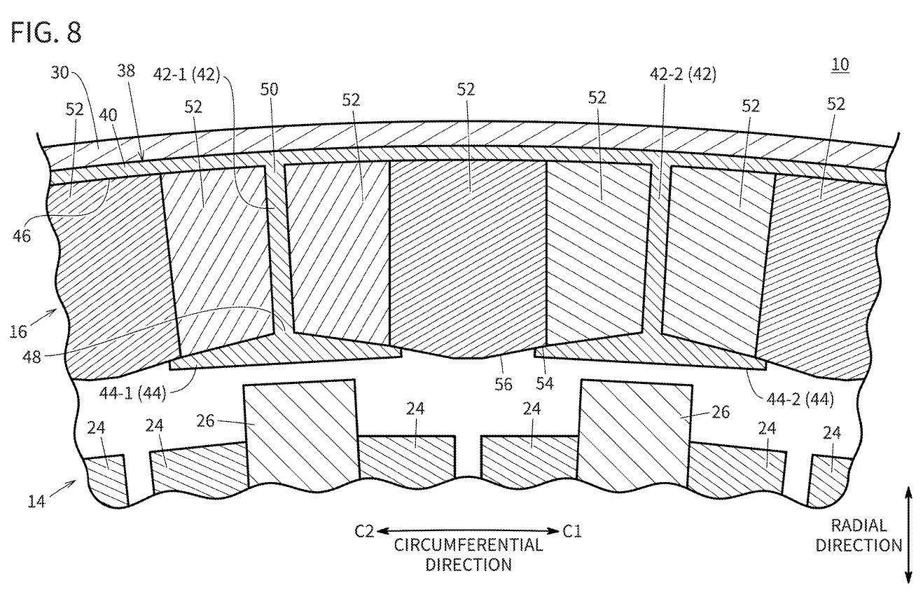

FIG. 8 is a partially enlarged view of a rotating electric machine 10 according to a fourth modification. In the first embodiment and the second embodiment described above, the four magnets 52 are located between the first rod portion 42-1 and the second rod portion 42-2. Further, two magnets 52 not in abutment with the rod portions 42 are located between the magnet 52 in abutment with the first rod portion 42-1 and the magnet 52 in abutment with the second rod portion 42-2. The present invention is not limited to this configuration, and as shown in FIG. 8, a single magnet 52 not in abutment with the rod portions 42 may be located between the magnet 52 in abutment with the first rod portion 42-1 and the magnet 52 in abutment with the second rod portion 42-2. In this case, the single magnet 52 may be in contact with at least one of the first flange portion 44-1 or the second flange portion 44-2.

### 8 Fifth Modification

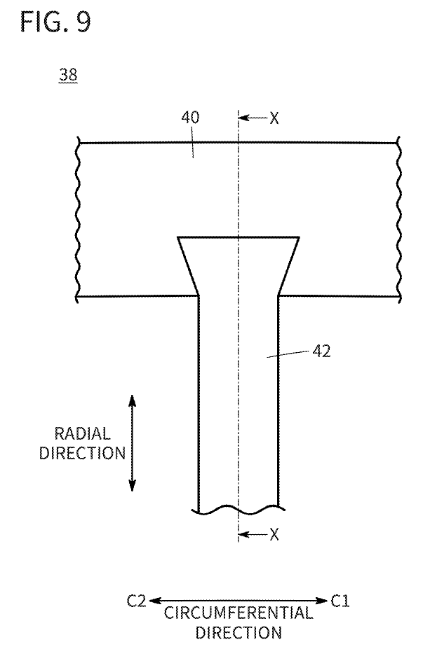

FIG. 9 is a schematic view of a magnet retaining member 38 according to a fifth modification. The base portion 40 and the rod portions 42 (and the flange portions 44) provided in the magnet retaining member 38 may be formed by separate members. In this case, each of the rod portions 42 is fixed to the base portion 40 by fitting.

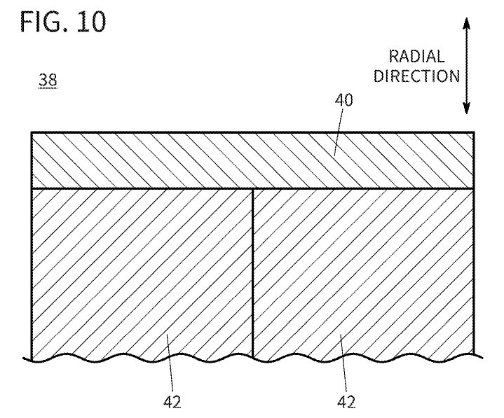

FIG. 10 is a cross-sectional view taken along line X-X of FIG. 9. In the fifth modification, each of the rod portions 42 may be divided along the circumferential direction. This facilitates assembly of the rod portions 42 to the base portion 40.

In relation to the above-described embodiments, the following supplementary notes are further disclosed.

### Supplementary Note 1

The rotating electric machine (10) according to the present disclosure includes the rotor (16) and the stator (14), wherein the rotor includes the plurality of magnets (52) arranged in the Halbach array along the circumferential direction of the rotor, and the magnet retaining member (38) configured to retain the plurality of magnets, the magnet retaining member includes the base portion (40) including the magnet retaining surface (46) along the circumferential direction of the rotor, the plurality of rod portions (42) protruding from the base portion along the radial direction of the rotor, and the flange portion (44) protruding from the protruding end (48) of each of the rod portions along the circumferential direction of the rotor, the magnets are each sandwiched and retained between the base portion and the flange portion, and the magnetization directions of two of the magnets adjacent to each other with one of the rod portions interposed between the two magnets are both along the radial direction of the rotor or both along the circumferential direction of the rotor.

In accordance with the above configuration, since all the magnets are sandwiched and retained between the base portion and the flange portions, the strength of the rotor can be ensured as compared with the case where the magnets are fixed by an adhesive.

In accordance with the above configuration, the rod portions do not need to have high rigidity as compared with a case that the magnets located on both sides of one of the rod portions have different magnetization directions. As a result, the weight of the magnet retaining member can be reduced, for example.

### Supplementary Note 2

In the rotating electric machine according to Supplementary Note 1, the plurality of magnets may include the plurality of main magnets (52m) having magnetization directions along the radial direction of the rotor, and the plurality of subsidiary magnets (52s) having magnetization directions along the circumferential direction of the rotor, and the two of the magnets adjacent to each other with the one of the rod portions interposed between the two magnets may be the subsidiary magnets.

### Supplementary Note 3

In the rotating electric machine according to Supplementary Note 2, the rod portions and the flange portion may be formed of the non-magnetic body.

In accordance with the above configuration, the torque can be increased as compared with a rotating electric machine including rod portions formed of a magnetic body.

### Supplementary Note 4

In the rotating electric machine according to Supplementary Note 2 or 3, all the subsidiary magnets among the plurality of magnets may be in abutment with the rod portions.

### Supplementary Note 5

In the rotating electric machine according to Supplementary Note 1, the plurality of magnets may include the plurality of main magnets having the magnetization directions along the radial direction of the rotor, and the plurality of subsidiary magnets having the magnetization directions along the circumferential direction of the rotor, and the two of the magnets adjacent to each other with the one of the rod portions interposed between the two magnets may be the main magnets.

### Supplementary Note 6

In the rotating electric machine according to Supplementary Note 5, the rod portions and the flange portion may be formed of the magnetic body.

In accordance with the above configuration, the torque can be increased as compared with a rotating electric machine including rod portions formed of a non-magnetic body.

### Supplementary Note 7

In the rotating electric machine according to Supplementary Note 5 or 6, all the main magnets among the plurality of magnets may be in abutment with the rod portions.

### Supplementary Note 8

In the rotating electric machine according to Supplementary Note 1, one of the magnets that is located between the first rod portion (42-1) and the second rod portion (42-2) adjacent to the first rod portion among the plurality of rod portions and that is not in abutment with the rod portions, may include the protruding portion (56) protruding into the clearance between the first flange portion (44-1) that is the flange portion protruding from the first rod portion and the second flange portion (44-2) that is the flange portion protruding from the second rod portion.

In accordance with the above configuration, the volume of the magnets is increased, and thus the torque of the rotating electric machine can be increased.

### Supplementary Note 9

In the rotating electric machine according to Supplementary Note 1, the gap formed between the magnet retaining member and each of the magnets may be filled with resin (58).

In accordance with the above configuration, since the movement of the magnets is suppressed, it is possible to suppress the stress generated in the rod portions due to the movement of the magnets.

### Supplementary Note 10

In the rotating electric machine according to Supplementary Note 1, a width of the base end portion (50) of each of the rod portions may increase toward the base portion when viewed in plan.

In accordance with the above configuration, the base end portion becomes thick, and thus the strength of the rod portions can be increased.

### Supplementary Note 11

In the rotating electric machine according to Supplementary Note 1, the rotor may located radially outward of the stator.

Although the present disclosure has been described in detail, the present disclosure is not necessarily limited to the specific embodiments described above. These embodiments can be subjected to various additions, substitutions, modifications, partial deletions and the like, within a range that does not depart from the essence and gist of the present disclosure, or alternatively, the purpose and gist of the present disclosure as derived from the contents described in the claims and their equivalents. Further, these embodiments can also be implemented in combination. For example, in the above-described embodiments, the order of the operations and the order of the processes are shown merely as examples, and the present invention is not necessarily limited to these examples. Further, the same also applies to cases in which numerical values or mathematical expressions are used in the description of the aforementioned embodiments.

1. A rotating electric machine comprising a rotor and a stator,
wherein the rotor includes a plurality of magnets arranged in a Halbach array along a circumferential direction of the rotor, and a magnet retaining member configured to retain the plurality of magnets,
the magnet retaining member includes a base portion including a magnet retaining surface along the circumferential direction of the rotor, a plurality of rod portions protruding from the base portion along a radial direction of the rotor, and a flange portion protruding from a protruding end of each of the rod portions along the circumferential direction of the rotor,
the magnets are each sandwiched and retained between the base portion and the flange portion, and
magnetization directions of two of the magnets adjacent to each other with one of the rod portions interposed between the two magnets are both along the radial direction of the rotor or both along the circumferential direction of the rotor.

2. The rotating electric machine according to claim 1, wherein the plurality of magnets include a plurality of main magnets having magnetization directions along the radial direction of the rotor, and a plurality of subsidiary magnets having magnetization directions along the circumferential direction of the rotor, and
the two of the magnets adjacent to each other with the one of the rod portions interposed between the two magnets are the subsidiary magnets.

3. The rotating electric machine according to claim 2, wherein the rod portions and the flange portion are formed of a non-magnetic body.

4. The rotating electric machine according to claim 2, wherein all the subsidiary magnets among the plurality of magnets are in abutment with the rod portions.

5. The rotating electric machine according to claim 1, wherein the plurality of magnets include a plurality of main magnets having magnetization directions along the radial direction of the rotor, and a plurality of subsidiary magnets having magnetization directions along the circumferential direction of the rotor, and
the two of the magnets adjacent to each other with the one of the rod portions interposed between the two magnets are the main magnets.

6. The rotating electric machine according to claim 5, wherein the rod portions and the flange portion are formed of a magnetic body.

7. The rotating electric machine according to claim 5, wherein all the main magnets among the plurality of magnets are in abutment with the rod portions.

8. The rotating electric machine according to claim 1, wherein one of the magnets that is located between a first rod portion and a second rod portion adjacent to the first rod portion among the plurality of rod portions and that is not in abutment with the rod portions, includes a protruding portion protruding into a clearance between a first flange portion that is the flange portion protruding from the first rod portion and a second flange portion that is the flange portion protruding from the second rod portion.

9. The rotating electric machine according to claim 1, wherein a gap formed between the magnet retaining member and each of the magnets is filled with resin.

10. The rotating electric machine according to claim 1, wherein a width of a base end portion of each of the rod portions increases toward the base portion when viewed in plan.

11. The rotating electric machine according to claim 1, wherein the rotor is located radially outward of the stator.
